(19) United States
(12) Patent Application Publication
(10) Pub. No.: US 2013/0301125 A1
(43) Pub. Date: Nov. 14, 2013

(54) VIDEO DISPLAY SYSTEM AND GLASSES DEVICE

(71) Applicant: SONY CORPORATION, Tokyo (JP)

(72) Inventor: RYO OGAWA, Kanagawa (JP)

(73) Assignee: SONY CORPORATION, Tokyo (JP)

(21) Appl. No.: 13/874,593

(22) Filed: May 1, 2013

(30) Foreign Application Priority Data
May 11, 2012 (JP) 2012109151

(51) Int. Cl. G02B 27/22

(52) U.S. Cl. CPC G02B 27/2264
USPC 359/465

(57) ABSTRACT

There is provided a video display system including a display device which multiplexes and displays a first image and a second image, and which converts light of the first image into first polarized light and converts light of the second image into second polarized light, and a glasses device which has left and right lenses that are respectively capable of being set to optical characteristics corresponding to the first polarized light and the second polarized light, and which selectively shields one of the light of the first image that has been converted into the first polarized light and the light of the second image that has been converted into the second polarized light.

### BACKGROUND

The technology disclosed in this specification relates to a video display system including a display device that multiplexes and displays a plurality of images and a glasses device that is used to observe the plurality of multiplexed images, and to the glasses device. Particularly, the technology relates to a video display system in which one glasses device is used to view a three-dimensional image and completely different images displayed by a display device, and to the glasses device.

A three-dimensional image that can be seen three-dimensionally can be presented to a viewer by displaying images having a parallax therebetween to left and right eyes. For example, in a three-dimensional video display system using glasses, a display device displays a left eye image and a right eye image using time division multiplexing or space division multiplexing. The glasses separate the multiplexed left and right eye images, and only light of the left eye image is allowed to enter the left eye while only light of the right eye image is allowed to enter the right eye. Then, the left eye image and the right eye image are fused in the brain of a user who is observing them, and are recognized as a three-dimensional image.

In a time-division three-dimensional video display method, the display device alternately displays the left eye image and the right eye image having a parallax between them in a very short cycle. The glasses are configured such that a left eye portion of the glasses allows transmission of light and a right eye portion of the glasses shields the light during a period in which the left eye image is displayed, and such that the right eye portion of the glasses allows transmission of light and the left eye portion of the glasses shields the light during a period in which the right eye image is displayed. For example, shutter glasses include liquid crystal shutters that are respectively disposed on the left eye portion and the right eye portion, and alternately perform an operation of opening/closing the left and right liquid crystal shutters in synchronization with switching of the left eye image and the right eye image by the display device. Thus, the shutter glasses can control incidence and shielding of light of the images to the left and right eyes (refer to JP 2011-39194A, for example). The shutter glasses are active glasses that drive and control the liquid crystal shutters, and the shutter glasses are expensive. Further, it is necessary to transmit a signal from the display device to the shutter glasses in order to control opening and closing timings of the liquid crystal shutters.

Further, an active retarder method is known as another example of the time-division three-dimensional video display method. More specifically, a phase plate that electrically controls a phase difference, namely, an active retarder, is disposed in front of a screen of a display device, and the phase difference of the active retarder is changed in a time division manner in synchronization with a display period of the left eye image and the right eye image. Thus, the light forming the left eye image is converted into left-handed circularly polarized light, and the light forming the right eye image is circularly polarized clockwise. Meanwhile, polarized glasses that the viewer wears are configured such that a polarized lens (a retarder) that corresponds to the left-handed circularly polarized light is attached to the left eye side and a polarized lens that corresponds to the right-handed circularly polarized light is attached to the right eye side. Therefore, the left eye image and the right eye image that have been time-division multiplexed are separated by passing through the polarized glasses, and can be observed by the left and right eyes, respectively (refer to JP 2011-242773A, for example). The polarized glasses are passive glasses that do not have a drive portion and can be provided at a low cost, unlike the shutter glasses.

Further, a pattern retarder method is known as a space-division three-dimensional video display method that uses passive glasses. Phase difference plates (pattern retarders) having different phase differences are provided in front of the screen of a display device such that they are alternately disposed for each of horizontal scanning lines, and the display device alternately displays on the screen a left eye image and a right eye image for each of the horizontal scanning lines. Here, the pattern retarders convert the light forming the left eye image into left-handed circularly polarized light, and convert the light forming the right eye image into right-handed circularly polarized light. The viewer can observe a three-dimensional image by wearing polarized glasses that have a polarized lens (a retarder) disposed on the left eye side that corresponds to the left-handed circularly polarized light, and a polarized lens disposed on the right eye side that corresponds to the right-handed circularly polarized light (refer to JP 2009-301039A, for example).

With the former method, i.e., the time-division three-dimensional video display method, three-dimensional images can be displayed without deterioration of resolution. However, since the left and right images are literally switched at a frame period of 50 Hz or 60 Hz, flickering of the screen may occur. Further, with the latter method, i.e., the space-division three-dimensional video display method, although the resolution deteriorates, flickering of the screen does not occur and it is possible to achieve comfortable viewing of three-dimensional images. Additionally, since the passive glasses are used, cost reductions can be achieved.

In either method, the three-dimensional video display method can be regarded as the technology that displays different view point images. As an application example of three-dimensional viewing, a video display system is known in which a single display device is used to simultaneously view completely different images. In this video display system, instead of left and right eye images, a plurality of different images P1 and P2 are displayed in a time division manner or a space division manner, for example. In this case, a certain viewer observes the image P1 using both his/her left and right eyes, and another viewer observes the image P2 using both his/her left and right eyes.

In a shutter glasses method, the shutter glasses electrically perform light modulation. Therefore, opening/closing operation timings of the shutter glasses may be controlled to shield the light of one of the images. For example, for the viewer who wants to view one of the images (the image P1), both the left and right liquid crystal shutters of the glasses are opened in synchronization with the display period of the image P1, and for the viewer who wants to view the other image (the image P2), both the left and right liquid crystal shutters of the glasses are opened in synchronization with the display period of the image P2. In summary, it is possible to simultaneously enjoy completely different images on a single display device, using the shutter glasses that are the same as those in the case of three-dimensional video display.

On the other hand, in the case of a passive glasses method, light modulation is performed based on a phase difference that is determined in advance. Therefore, one of the left and right retarders shields the light of the image, and it is difficult that the viewer simultaneously views the same image using both his/her left and right eyes. If a display device 100 displays the plurality of images P1 and 2 in a time division manner or a space division manner, the image P1 is incident to one of the eyes and the image P2 is incident to the other eye, and both the images P1 and P2 are difficult to be viewed properly. In summary, it is not possible to simultaneously enjoy different images on a single display device, using passive glasses that are the same as those in the case of three-dimensional video display.

### SUMMARY

The technology disclosed in this specification provides an excellent video display system that makes it possible to view a three-dimensional image and completely different images displayed by a display device using one glasses device, and the glasses device.

In light of foregoing, according to an embodiment of the present technology, there is provided a video display system including a display device which multiplexes and displays a first image and a second image, and which converts light of the first image into first polarized light and converts light of the second image into second polarized light, and a glasses device which has left and right lenses that are respectively capable of being set to optical characteristics corresponding to the first polarized light and the second polarized light, and which selectively shields one of the light of the first image that has been converted into the first polarized light and the light of the second image that has been converted into the second polarized light.

The “system” used herein refers to an assembly obtained by logically assembling a plurality of devices (or functional modules realizing specific functions), regardless of whether or not devices or functional modules are in a single housing.

The display device may include a three-dimensional image display mode that displays a left eye image and a right eye image as the first image and the second image, and a multiple image display mode that displays images different from each other as the first image and the second image.

The glasses device may set the optical characteristic corresponding to one of the first polarized light and the second polarized light, in accordance with mounting positions of the left and right lenses.

The glasses device may be capable of setting the optical characteristic corresponding to one of the first polarized light and the second polarized light, separately for the left and right lenses.

The glasses device may be capable of setting the optical characteristic corresponding to one of the first polarized light and the second polarized light, for the left and right lenses as a unit.

The display device may include a λ/4 phase difference plate that converts each of the first image and the second image to one of left-handed circularly polarized light and right-handed circularly polarized light. The left and right lenses of the glasses device may be each formed of a polarizing plate that has a first λ/4 phase difference plate on a front side and a second λ/4 phase difference plate on a back side.

A slow axis of the first λ/4 phase difference plate may match a slow axis of the second λ/4 phase difference plate.

A slow axis of the first λ/4 phase difference plate and a slow axis of the second λ/4 phase difference plate may be displaced from each other by 90 degrees.

The glasses device may include a reversal mechanism that reverses the front and back of the first λ/4 phase difference plate and the second λ/4 phase difference plate. The glasses device may set the optical characteristic to one of an optical characteristic corresponding to the left-handed circularly polarized light and an optical characteristic corresponding to the right-handed circularly polarized light, by reversing the front and back of the first λ/4 phase difference plate and the second λ/4 phase difference plate.

The reversal mechanism may reverse the front and back of the first λ/4 phase difference plate and the second λ/4 phase difference plate, separately for the left and right lenses.

The reversal mechanism may individually and rotatably support the left and right lenses by a bridge portion between the left and right lenses.

The reversal mechanism may reverse the front and back of the first λ/4 phase difference plate and the second λ/4 phase difference plate, for the left and right lenses as a unit.

The reversal mechanism may switch a front-rear direction of left and right temple portions with respect to an eyeglass frame that holds the left and right lenses.

The display device may include a λ/2 phase difference plate that converts each of the first image and the second image into one of vertical linearly polarized light and horizontal linearly polarized light. The left and right lenses of the glasses device may be each formed by a polarizing plate that has a first λ/2 phase difference plate on a front side and a second λ/2 phase difference plate on a back side.

The glasses device may include a reversal mechanism that reverses the front and back of the first λ/2 phase difference plate and the second λ/2 phase difference plate. And the glasses device may set the optical characteristic to one of an optical characteristic corresponding to the vertical linearly polarized light and an optical characteristic corresponding to the horizontal linearly polarized light, by reversing the front and back of the first λ/2 phase difference plate and the second λ/2 phase difference plate.

Further, according to an embodiment of the present disclosure, there is provided a glasses device including left and right lenses that are respectively capable of being set to optical characteristics corresponding to first polarized light and second polarized light. The glasses device selectively shields one of light of a first image that has been converted into the first polarized light and light of a second image that has been converted into the second polarized light.

The left and right lenses may be each formed of a polarizing plate that has a first λ/2 phase difference plate on a front side and a second λ/2 phase difference plate on a back side.

The glasses device may further include a reversal mechanism that reverses the front and back of the first λ/2 phase difference plate and the second λ/2 phase difference plate. The glasses device may set the optical characteristic to one of an optical characteristic corresponding to vertical linearly polarized light and an optical characteristic corresponding to horizontal linearly polarized light, by reversing the front and back of the first λ/2 phase difference plate and the second λ/2 phase difference plate.

The reversal mechanism individually and rotatably may support the left and right lenses by a bridge portion between the left and right lenses.

The reversal mechanism may switch a front-rear direction of left and right temple portions with respect to an eyeglass frame that holds the left and right lenses.

According to the technology disclosed in this specification, it is possible to provide an excellent video display system that makes it possible to view a three-dimensional image and completely different images displayed by a display device using one glasses device, and the glasses device.

Features and advantageous effects of the technology disclosed in this specification will become apparent from a more detailed explanation based on a later-described embodiment and the appended drawings.

### BRIEF DESCRIPTION OF THE DRAWINGS

FIG. 1 is a diagram schematically showing a functional configuration of a display device 100 to which the technology disclosed in this specification can be applied;

FIG. 2 is a diagram showing a configuration of a video display system that includes passive glasses 200 proposed in this specification;

FIG. 3 is a diagram showing a manner in which the display device 100 multiplexes and displays different images P1 and P2 and in which one of the images (the image P2) is viewed through the passive glasses 200, in the video display system shown in FIG. 2;

FIG. 4 is a diagram showing a manner in which the display device 100 multiplexes and displays the different images P1 and P2 and in which one of the images (the image P1) is viewed through the passive glasses 200, in the video display system shown in FIG. 2;

FIG. 5 is a diagram showing another configuration of the video display system that includes the passive glasses 200 proposed in this specification;

FIG. 6 is a diagram showing a manner in which the display device 100 multiplexes and displays the different images P1 and P2 and in which one of the images (the image P2) is viewed through the passive glasses 200, in the video display system shown in FIG. 5;

FIG. 7 is a diagram showing a manner in which the display device 100 multiplexes and displays the different images P1 and P2 and in which one of the images (the image P1) is viewed through the passive glasses 200, in the video display system shown in FIG. 5;

FIG. 8 is a diagram showing another configuration example of the passive glasses 200 proposed in this specification;

FIG. 9 is a diagram showing another configuration example of the passive glasses 200 proposed in this specification;

FIG. 10 is a diagram illustrating an operation principle of a video display system using a pattern retarder method;

FIG. 11 is a diagram illustrating the operation principle of the video display system using the pattern retarder method;

FIG. 12 is a diagram showing a manner in which the different images P1 and P2 are viewed in the video display system shown in FIG. 10;

FIG. 13 is a diagram showing passive glasses in which left and right polarized lenses both have an optical characteristic corresponding to left-handed circularly polarized light; and

FIG. 14 is a diagram showing passive glasses in which left and right polarized lenses both have an optical characteristic corresponding to right-handed circularly polarized light.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

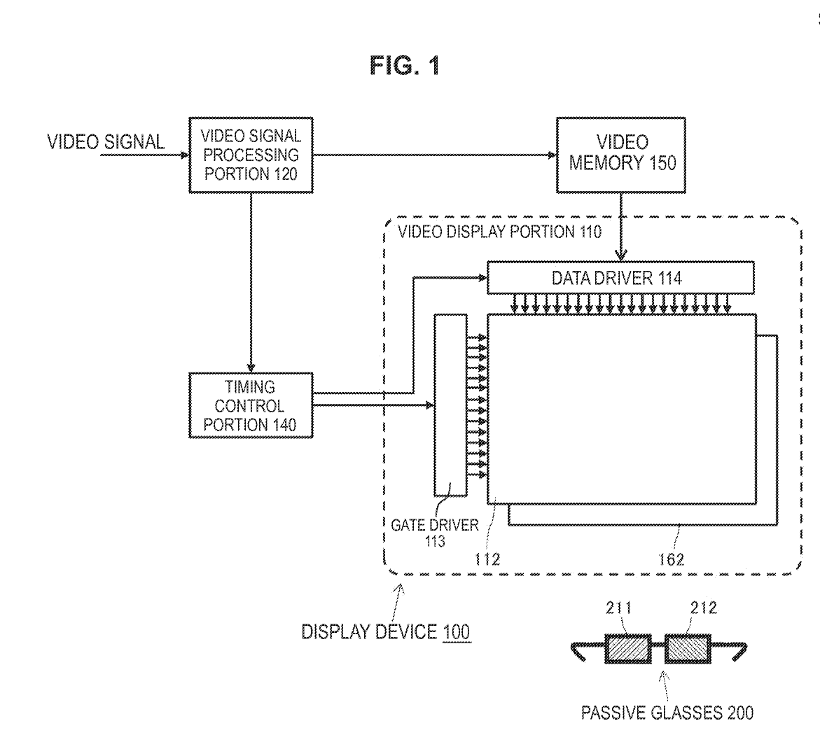

FIG. 1 schematically shows a functional configuration of a display device 100 to which the technology disclosed in this specification can be applied. FIG. 1 also shows passive glasses 200 that are used when a viewer observes an image displayed on the display device 100.

The display device 100 is provided with a video display portion 110, a video signal processing portion 120, a timing control portion 140 and a video memory 150.

When the video signal processing portion 120 receives a video signal transmitted from an external device provided outside the video signal processing portion 120, the video signal processing portion 120 performs various types of signal processing so that the video signal becomes appropriate for video display by the video display portion 110, and outputs the processed video signal. For example, when the video signal processing portion 120 inputs a three-dimensional image or two different images, the video signal processing portion 120 alternately draws a left eye image and a right eye image or two different images P1 and P2 for each of horizontal scanning lines, and thereby generates an image for one frame. The generated image is supplied to the video memory 150. Further, the video signal processing portion 120 supplies a predetermined control signal to the timing control portion 140 so that a gate driver 113 and a data driver 114 operate in synchronization with a video signal switching timing. Note that the “external device” that is a transmission source of the video signal may be, for example, a digital broadcasting receiver or a content playback device, such as a blue-ray disc player.

The video display portion 110 displays an image in accordance with a signal transmitted from the external device. The video display portion 110 is provided with a display panel 112, the gate driver 113, the data driver 114 and a light source 162.

The gate driver 113 is a drive circuit that generates a signal to sequentially drive gate bus lines. The gate driver 113 outputs a drive voltage to the gate bus lines connected to each of pixels in the display panel 112, in accordance with a signal transmitted from the timing control portion 140. The data driver 114 is a drive circuit that outputs a drive voltage based on a video signal. The data driver 114 generates and outputs a signal that is applied to data lines based on the signal transmitted from the timing control portion 140 and the video signal read out from the video memory 150.

The display panel 112 includes the plurality of pixels arranged in a matrix manner, for example. In the case of a liquid crystal display panel, liquid crystal molecules having a predetermined orientation are filled in a space between transparent plates made of glass or the like, and an image is displayed in accordance with a signal applied from an external device. As described above, the application of signals to the display panel 112 is performed by the gate driver 113 and the data driver 114.

The light source 162 is a back light that is provided on the furthermost side of the video display portion 110 as seen from the viewer. When an image is displayed on the video display portion 110, unpolarized white light is incident from the light source 162 to the display panel 112 positioned on the viewer side.

Note that, although this specification describes the embodiment in which a liquid crystal display is used as the video display portion 110, the gist of the technology disclosed in this specification is not limited to this example. For example, the present technology can also be applied to another display, such as an organic light emitting diode (OLED) display, a light emitting diode (LED) display or the like, which is configured such that a plurality of pixels, each of which is formed by a plurality of color component cells, are sequentially arranged in a horizontal direction and a vertical direction.

The display device 100 spatially modulates and displays a left eye image and a right eye image or two different images. The display device 100 and the passive glasses 200 are combined to form a video display system using a pattern retarder method

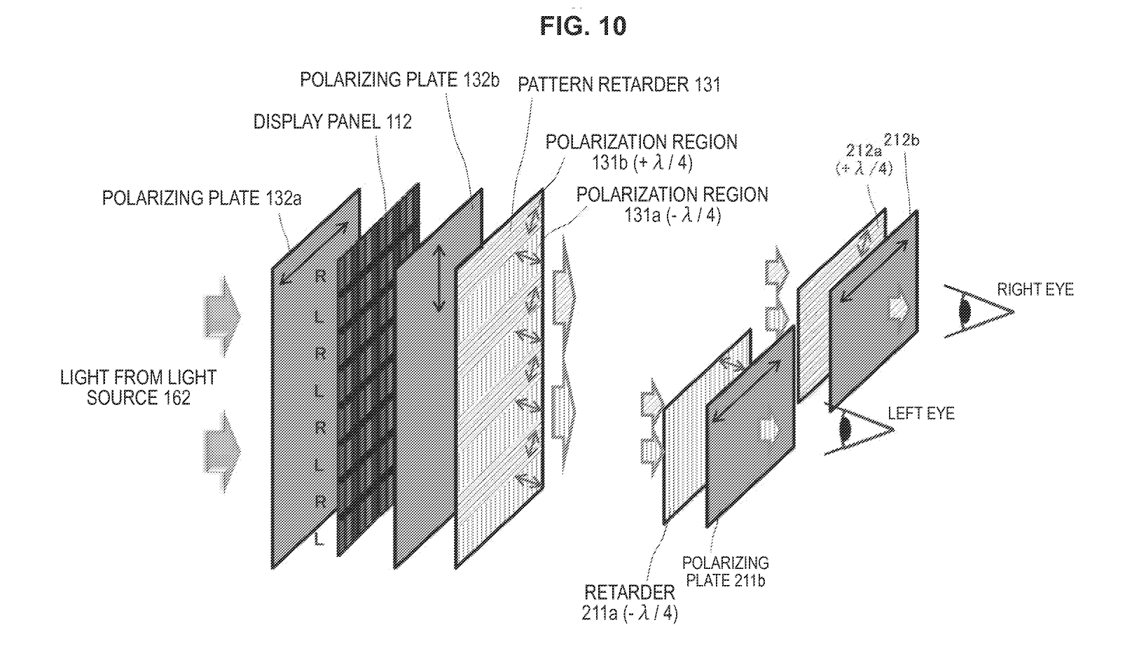

Here, an operation principal of the video display system using the pattern retarder method will be explained with reference to FIG. 10. In FIG. 10, the display device 100 is seen from the side. As shown in FIG. 10, polarizing plates 132a and 132b, whose polarizing directions are orthogonal to each other, are respectively provided by adhesion on a rear surface and a front surface of the display panel 112. Further, a phase difference plate having polarization regions 131a and 131b that are alternately switched for each of the horizontal scanning lines, namely, a pattern retarder 131, is disposed in front of the display panel 112. The polarization region 131a has a phase difference of −λ/4 and the polarization region 131b has a phase difference of +λ/4 (where λ is a wavelength to be used).

When the display device 100 displays a three-dimensional image, the display panel 112 alternately displays a right eye image R and a left eye image L for each of the horizontal scanning lines, in response to the applied video signal. The light from the light source 162 is polarized by the display panel 112 formed by the polarizing plates 132a and 132b and liquid crystal elements. Further, the light that has passed through the polarizing plate 132b is circularly polarized by the pattern retarder 131 that is disposed in front of the polarizing plate 132b. More specifically, for each of the horizontal scanning lines, the pattern retarder 131 converts the left eye image L into left-handed circularly polarized light by the polarization region 131a having a phase difference of −λ/4, and also converts the right eye image R into right-handed circularly polarized light by the polarization region 131b having a phase difference of +λ/4.

Meanwhile, a left eye lens 211 of the passive glasses 200 includes a retarder 211a having a phase difference of −λ/4, which is disposed on the front side of a polarizing plate 211b. Thus, the left eye lens 211 has an optical characteristic that corresponds to the left-handed circularly polarized light of the left eye image L. A right eye lens 212 of the passive glasses 200 includes a retarder 212a having a phase difference of +λ/4, which is disposed on the front side of a polarizing plate 212b. Thus, the right eye lens 212 has an optical characteristic that corresponds to the right-handed circularly polarized light of the right eye image R. As a result, only the left eye image L reaches the left eye of the viewer who is wearing the passive glasses 200 because the light of the right eye image R is shielded, and only the right eye image R reaches the right eye of the viewer because the light of the left eye image L is shielded.

In this manner, when the viewer views a three-dimensional image displayed on the display device 100 through the passive glasses 200, the viewer can visually recognize the left eye image L and the right eye image R by the left eye and the right eye, separately and respectively, and can perform stereoscopic viewing.

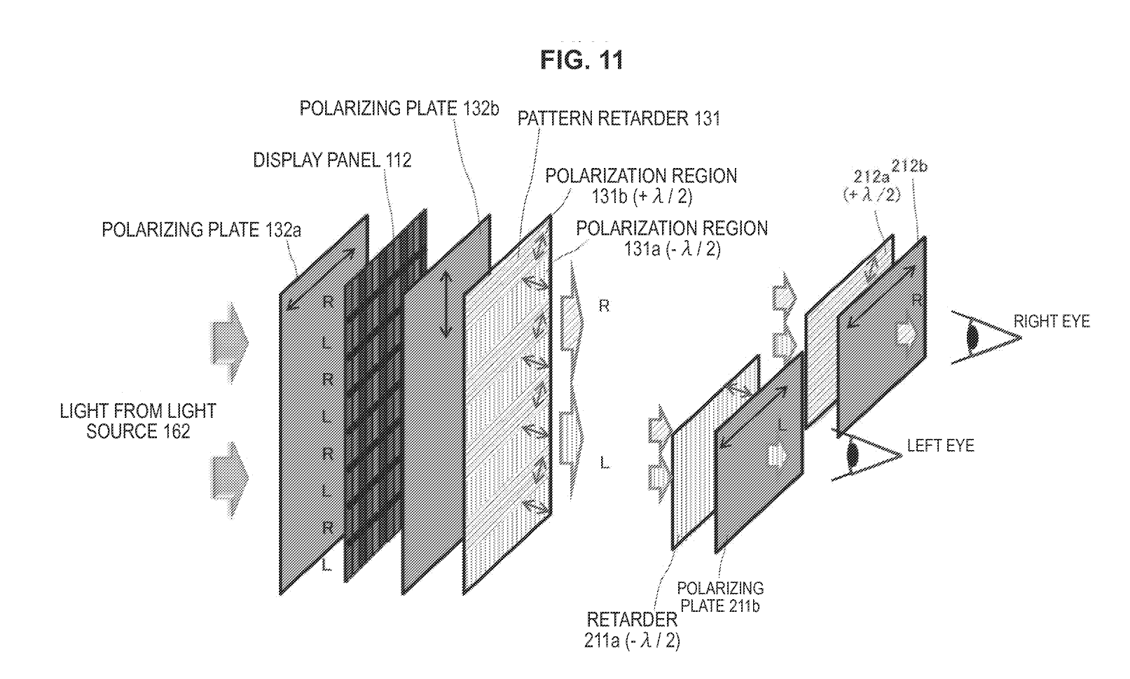

Note that, although it is necessary that respective optical axes of the polarization region 131a and the polarization region 131b of the pattern retarder 131 are orthogonal to each other, the phase difference does not have to be ±λ/4. For example, as shown in FIG. 11, the pattern retarder 131 may be configured such that one of the polarization regions, the polarization region 131a, has a phase difference of −λ/2 and the other polarization region 131b has a phase difference of +λ/2, and the left eye image L and the right eye image R are respectively converted into one of vertical linearly polarized light and horizontal linearly polarized light. Further, the left eye side retarder 211a and the right eye side retarder 212a of the passive glasses 200 respectively have a phase difference of −λ/2 and a phase difference of +λ/2, and have optical characteristics corresponding to the vertical linearly polarized light and the horizontal linearly polarized light. Therefore, in the same manner as the system configuration example shown in FIG. 10, when the viewer views a three-dimensional image displayed on the display device 100 through the passive glasses 200, the viewer can visually recognize the left eye image L and the right eye image R by the left eye and the right eye, separately and respectively, and can perform stereoscopic viewing.

The three-dimensional video display method can be regarded as the technology that displays different view point images. As an application example of three-dimensional viewing, there is a video display system in which a single display device is used to simultaneously view completely different images, instead of left and right images. For example, if the image P1 of a first player and the image P2 of a second player are multiplexed and displayed, it is possible to simultaneously enjoy role playing games using a single display device.

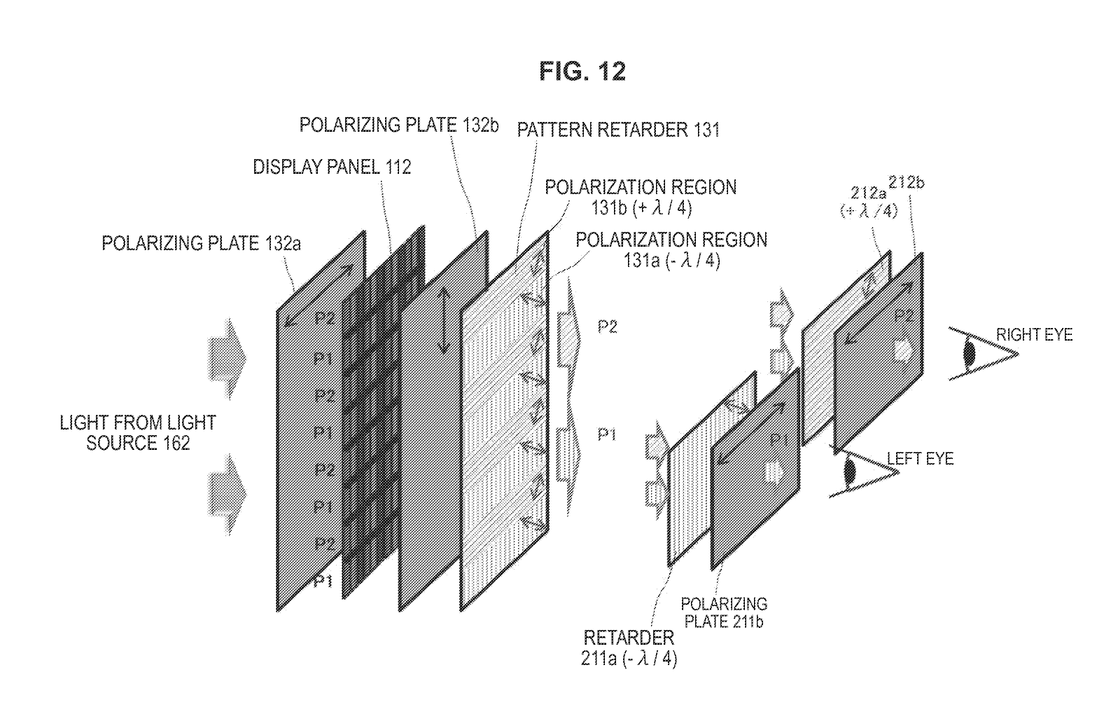

In the case of the passive glasses method, light modulation is performed based on the phase difference of the left and right retarders determined in advance, as described above. Here, referring to FIG. 12, a case is considered in which the display device 100 displays not a three-dimensional image but images obtained by space-division multiplexing of the two different images P1 and P2 and the displayed images are observed through the passive glasses 200, in the video display system shown in FIG. 10.

The display panel 112 alternately displays the image P1 and image P2 for each of the horizontal scanning lines, in response to the applied video signal. The pattern retarder 131 converts one of the images, the image P1, into left-handed circularly polarized light by the polarization region 131a having a phase difference of −λ/4, and also converts the other image P2 into right-handed circularly polarized light by the polarization region 131b having a phase difference of +λ/4. Meanwhile, the left eye side of the passive glasses 200 includes the retarder 211a having a phase difference of −λ/4, which is disposed on the front side of the polarizing plate 211b, and thus the left eye side has an optical characteristic that corresponds to the left-handed circularly polarized light. The right eye side of the passive glasses 200 includes the retarder 212a having a phase difference of +λ/4, which is disposed on the front side of the polarizing plate 212b, and thus the right eye side has an optical characteristic that corresponds to the right-handed circularly polarized light. Therefore, only the image P1 reaches the left eye of the viewer who is wearing the passive glasses 200 because the light of the image P2 is shielded, and only the image P2 reaches the right eye of the viewer because the light of the image P1 is shielded. As a result, both the images P1 and P2 are difficult to be viewed properly.

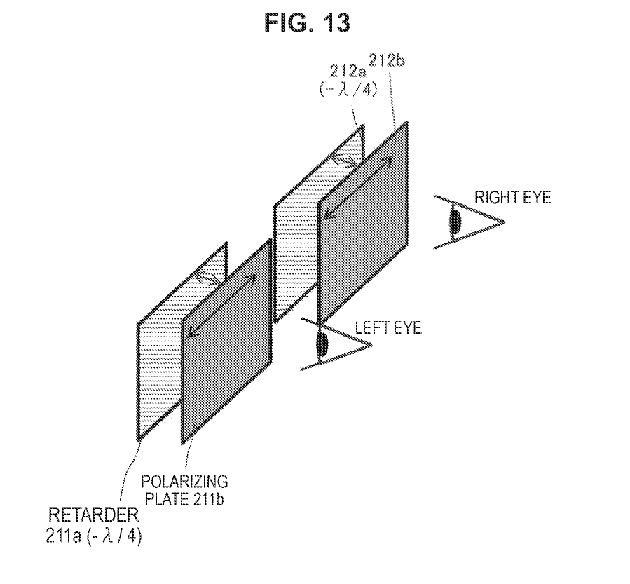

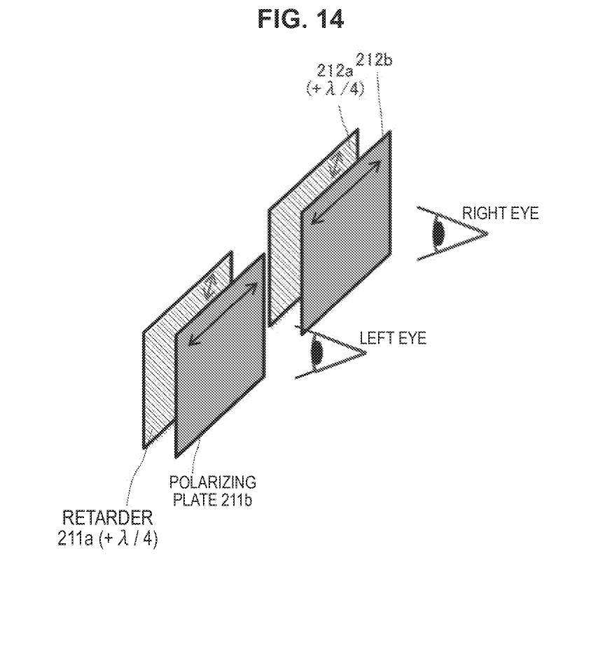

In order to respectively and properly observe the different images P1 and P2 that are spatially divided and displayed on the display device 100, when the image P1 is viewed, the passive glasses shown in FIG. 13 are used, in which the retarders 211a and 212a that have a phase difference of −λ/4 are disposed on the left and right sides, and both the left and right polarized lenses have an optical characteristic corresponding to the left-handed circularly polarized light of the image P1. In the same manner, when the image P2 is viewed, the passive glasses shown in FIG. 14 are used, in which the retarders 211a and 212a that have a phase difference of +λ/4 are disposed on the left and right sides, and both the left and right polarized lenses have an optical characteristic corresponding to the right-handed circularly polarized light of the image P2. It is necessary to separately use the three types of passive glasses, including the passive glasses 200 (refer to FIG. 10), for viewing three-dimensional images. Separate use of the plurality of glasses in accordance with an image display mode causes confusion and troublesome operation for a user. In addition, preparation of the plurality of passive glasses results in a cost increase.

To address this, in this specification, passive glasses are proposed that can be used when the display device 100 displays a three-dimensional image and also when the display device 100 displays the different images P1 and P2.

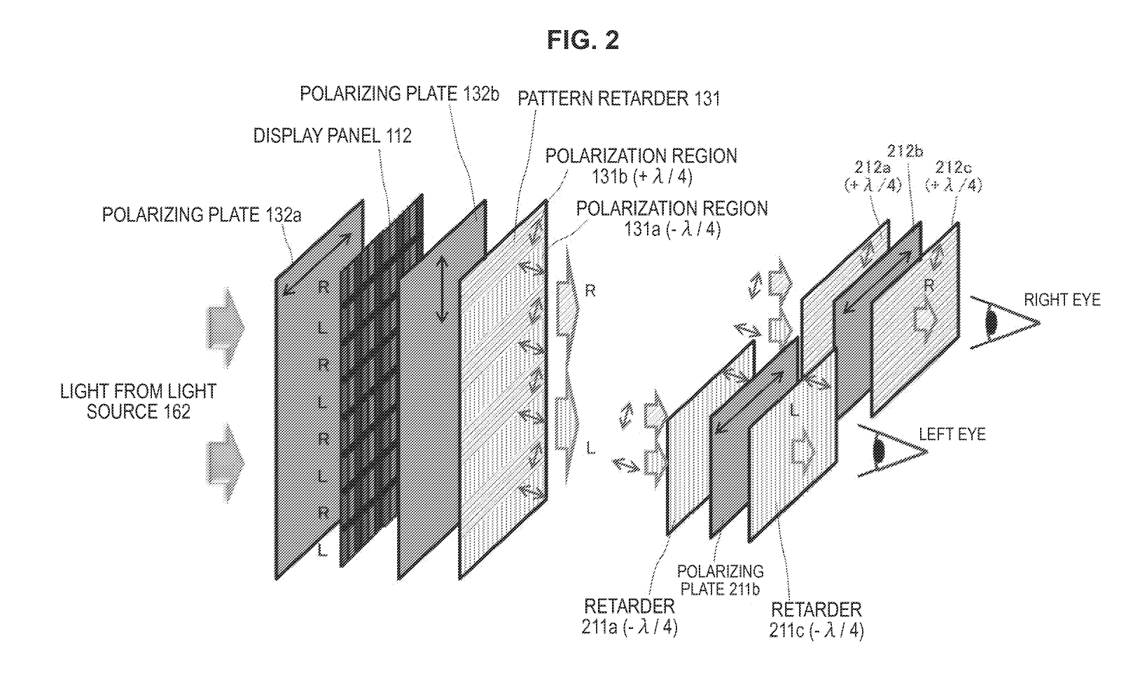

FIG. 2 shows a configuration of a video display system that includes the passive glasses 200 proposed in this specification. The display device 100 is provided with the pattern retarder 131 in which the polarization region 131a has a phase difference of −λ/4 and the polarization region 131b has a phase difference of +λ/4. Meanwhile, the passive glasses 200 include the first retarder 211a having a phase difference of −λ/4 that is disposed on the front side of the left eye side polarizing plate 211b, and a second retarder 211c having a phase difference of −λ/4 that is disposed on the back side of the polarizing plate 211b. It is necessary that a slow axis of the first retarder 211a matches a slow axis of the second retarder 211c, or that the slow axes are displaced from each other by 90 degrees. In the example shown in FIG. 2, both the first retarder 211a and the second retarder 211c have a phase difference of −λ/4, and have an optical characteristic corresponding to the left-handed circularly polarized light. Further, the first retarder 212a having a phase difference of +λ/4 is disposed on the front side of the right eye side polarizing plate 212b, and a second retarder 212c having a phase difference of +λ/4 is disposed on the back side of the polarizing plate 212b. It is necessary that a slow axis of the first retarder 212a matches a slow axis of the second retarder 212c, or that the slow axes are displaced from each other by 90 degrees. In the example shown in FIG. 2, both the first retarder 212a and the second retarder 212c have a phase difference of +λ/4, and have an optical characteristic corresponding to the right-handed circularly polarized light.

When the display device 100 displays a three-dimensional image, the display device 100 alternately displays the left eye image L and the right eye image R for each of the horizontal scanning lines of the display panel 112. The left eye image L is converted into the left-handed circularly polarized light by the polarization region 131a of the pattern retarder 131, and the right eye image R is converted into the right-handed circularly polarized light by the polarization region 131b. Therefore, only the left eye image L reaches the left eye of the viewer who is wearing the passive glasses 200 because the light of the right eye image R is shielded, and only the right eye image R reaches the right eye of the viewer because the light of the left eye image L is shielded. Thus, the viewer can stereoscopically view the image.

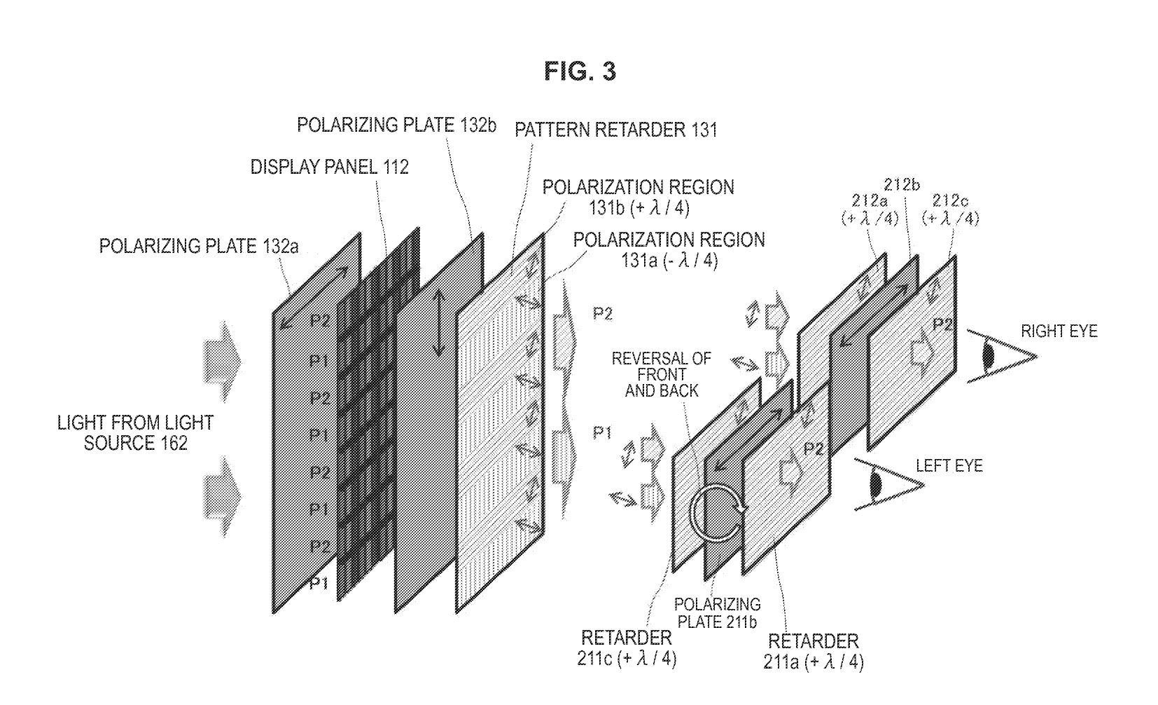

The passive glasses 200 shown in FIG. 2 are novel in that they have a mechanism of switching optical characteristics of the left and right lenses. When the first retarder 211a and the second retarder 211c each having a phase difference of −λ/4 are respectively disposed on the front side and the back side of the polarizing plate 211b as shown in FIG. 2, the optical characteristic of the lens on the left eye side can be switched from the optical characteristic corresponding to the left-handed circularly polarized light to the optical characteristic corresponding to the right-handed circularly polarized light, by reversing the front and back of the first retarder 211a and the second retarder 211c on the left eye side, as shown in FIG. 3.

When the display device 100 alternately displays the different images P1 and P2 for each of the horizontal scanning lines of the display panel 112, one of the images, the image P1, is converted into the left-handed circularly polarized light, and the other image P2 is converted into the right-handed circularly polarized light. Therefore, only the image P2, which has been converted into the right-handed circularly polarized light, reaches both the left and right eyes of the viewer who is wearing the passive glasses 200 because the light of the image P1 that has been converted into the left-handed circularly polarized light is shielded, and thus the viewer can view the image P2 properly.

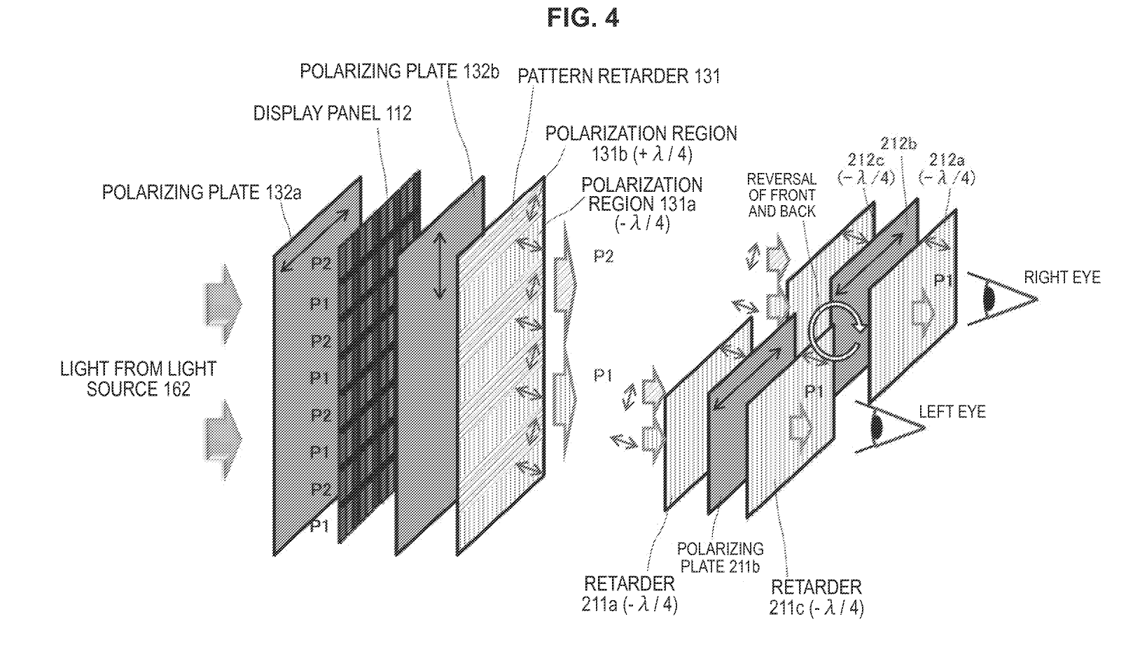

Similarly, on the right eye side, the optical characteristic of the lens on the right eye side can be switched from the optical characteristic corresponding to the right-handed circularly polarized light to the optical characteristic corresponding to the left-handed circularly polarized light, by reversing the front and back of the first retarder 212a and the second retarder 212c on the right eye side, as shown in FIG. 4.

When the display device 100 alternately displays the different images P1 and P2 for each of the horizontal scanning lines of the display panel 112, only the image P1, which has been converted into the left-handed circularly polarized light, reaches both the left and right eyes of the viewer who is wearing the passive glasses 200 because the light of the image P2 that has been converted into the right-handed circularly polarized light is shielded, and thus the viewer can view the image P1 properly.

As shown in FIG. 2 to FIG. 4, by combining the retarders having a phase difference of ±λ/4 and the polarizing plates, it is possible to form the passive glasses 200 that have the lenses having a left-handed circularly polarized light characteristic or a right-handed circularly polarized light characteristic. Then, by reversing the front and back of each of the left and right lenses, it is possible to switch the optical characteristic of each lens from the left-handed circularly polarized light characteristic to the right-handed circularly polarized light characteristic, or from the right-handed circularly polarized light characteristic to the left-handed circularly polarized light characteristic. For example, if a structure is adopted in which the left and right lenses are supported rotatably (around a pitch axis) by a bridge portion of the glasses, it is possible to switch the optical characteristic by reversing the front and back of each of the lenses. Alternatively, if a structure is adopted in which each of the left and right lenses can be freely removed from an eyeglass frame and can be attached in both the front and back directions, it is possible to switch the optical characteristic by reversing the front and back of each of the lenses.

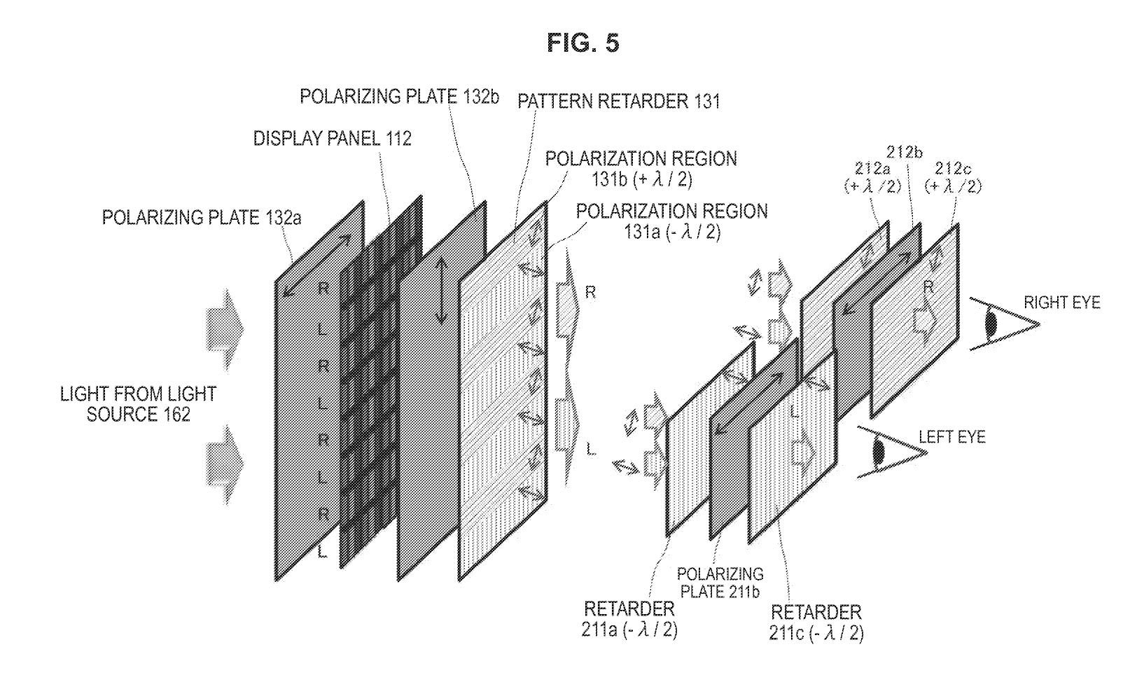

FIG. 5 shows another configuration of the video display system that includes the passive glasses 200 proposed in this specification. The display device 100 is provided with the pattern retarder 131 that has the polarization region 131a and the polarization region 131b that respectively have a phase difference of −λ/2 and a phase difference of +λ/2. Meanwhile, the passive glasses 200 are configured such that both the first retarder 211a and the second retarder 211c on the left eye side have a phase difference of −λ/2 and have an optical characteristic corresponding to horizontal linearly polarized light. Further, both the first retarder 212a and the second retarder 212c on the right eye side have a phase difference of +λ/2 and have an optical characteristic corresponding to vertical linearly polarized light.

When the display device 100 displays a three-dimensional image, the display device 100 alternately displays the left eye image L and the right eye image R for each of the horizontal scanning lines of the display panel 112. The left eye image L is converted into horizontal linearly polarized light by the polarization region 131a of the pattern retarder 131, and the right eye image R is converted into vertical linearly polarized light by the polarization region 131b. Therefore, only the left eye image L reaches the left eye of the viewer who is wearing the passive glasses 200 because the light of the right eye image R is shielded, and only the right eye image R reaches the right eye of the viewer because the light of the left eye image L is shielded. Thus, the viewer can stereoscopically view the image.

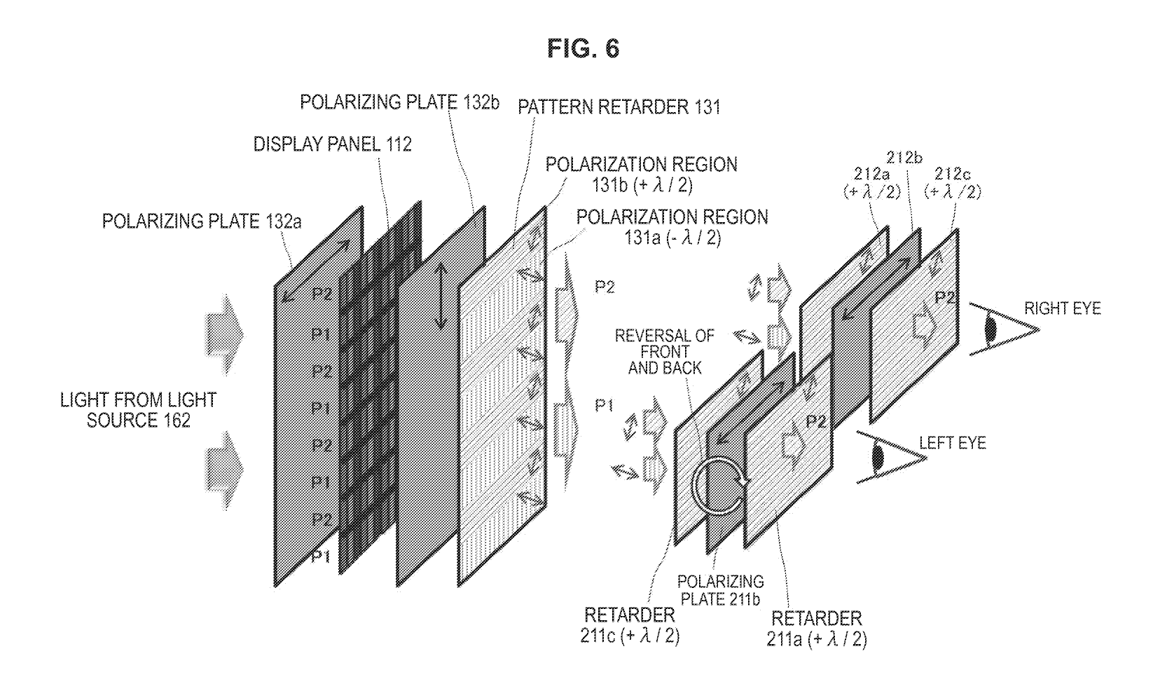

Further, the passive glasses 200 shown in FIG. 5 have a mechanism that switches the optical characteristic of each of the left and right lenses. When the first retarder 211a and the second retarder 211c each having a phase difference of λ/2 are respectively disposed on the front side and the back side of the polarizing plate 211b as shown in FIG. 5, the optical characteristic of the lens on the left eye side can be switched from the optical characteristic corresponding to the horizontal linearly polarized light to the optical characteristic corresponding to the vertical linearly polarized light, by reversing the front and back of the first retarder 211a and the second retarder 211c on the left eye side, as shown in FIG. 6.

When the display device 100 alternately displays the different images P1 and P2 for each of the horizontal scanning lines of the display panel 112, one of the images, the image P1, is converted into the horizontal linearly polarized light, and the other image P2 is converted into the vertical linearly polarized light. Therefore, only the image P2, which has been converted into the vertical linearly polarized light, reaches both the left and right eyes of the viewer who is wearing the passive glasses 200 because the light of the image P1 that has been converted into the horizontal linearly polarized light is shielded, and thus the viewer can view the image P2 properly.

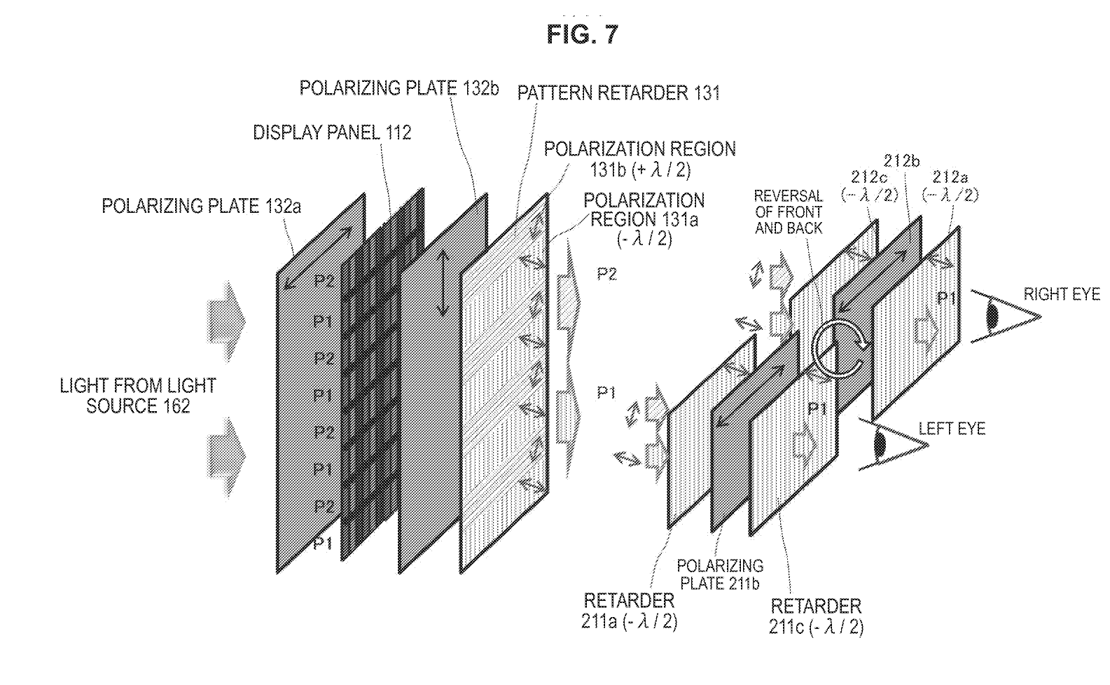

Similarly, on the right eye side, the optical characteristic of the lens on the right eye side can be switched from the optical characteristic corresponding to the vertical linearly polarized light to the optical characteristic corresponding to the horizontal linearly polarized light, by reversing the front and back of the first retarder 212a and the second retarder 212c on the right eye side, as shown in FIG. 7.

When the display device 100 alternately displays the different images P1 and P2 for each of the horizontal scanning lines of the display panel 112, only the image P1, which has been converted into the horizontal linearly polarized light, reaches both the left and right eyes of the viewer who is wearing the passive glasses 200 because the light of the image P2 that has been converted into the vertical linearly polarized light is shielded, and thus the viewer can view the image P1 properly.

As described above, if the structure is adopted in which the left and right lenses of the passive glasses are supported rotatably (around the pitch axis) by the bridge portion of the glasses, or if the structure is adopted in which the left and right lenses are detachable, it is possible to achieve, with respect to the left and right lenses, three types of combinations of optical characteristics, namely, (left-handed circularly polarized light, right-handed circularly polarized light), (left-handed circularly polarized light, left-handed circularly polarized light) and (right-handed circularly polarized light, right-handed circularly polarized light), or three types of combinations of optical characteristics, namely, (vertical linearly polarized light, horizontal linearly polarized light), (vertical linearly polarized light, vertical linearly polarized light) and (horizontal linearly polarized light, horizontal linearly polarized light). Thus, the single pair of passive glasses can be used both when the display device 100 displays a three-dimensional image and when the display device 100 displays the different images P1 and P2.

However, if the structure in which the left and right lenses are rotatably supported by the bridge portion of the glasses or the structure in which the left and right lenses are detachable is adopted, the structure of the eyeglass frame becomes complicated. As a result, design constraints increase and there is concern that costs will increase.

To address this, in place of the structure in which the bridge portion rotates or the structure in which the left and right lenses are detachable, a structure may be adopted in which the front-rear direction of left and right temple portions can be changed with respect to the eyeglass frame that holds the left and right lenses having the same optical characteristic.

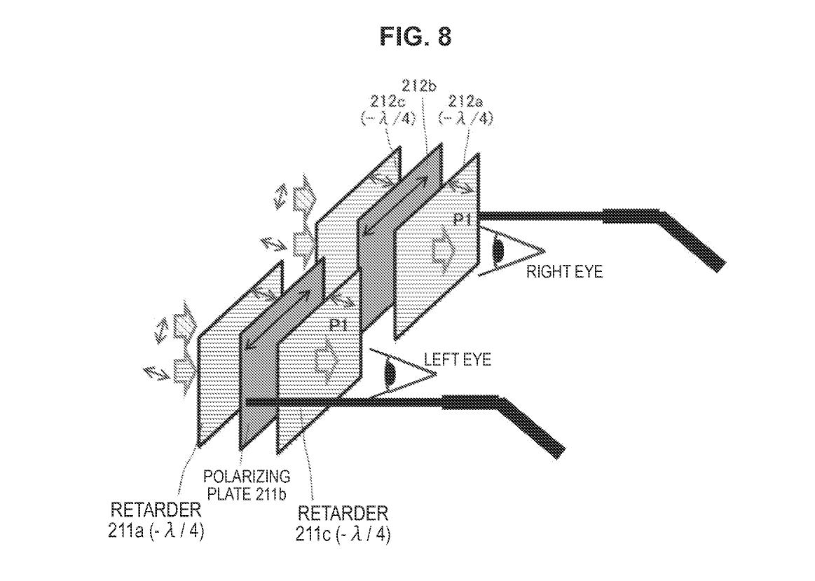

In the passive glasses 200 shown in FIG. 8, both the first retarder 211a and the second retarder 211c have a phase difference of −λ/4, and both the first retarder 212a and the second retarder 212c have a phase difference of −λ/4. The eyeglass frame (not shown in the drawings) fixes the left and right lenses in the direction shown in FIG. 8, in which the left and right lenses have the same optical characteristic. Note that the passive glasses 200 in this case are adapted to be used with the display device 100 that is provided with the pattern retarder 131 in which the polarization region 131a and the polarization region 131b respectively have a phase difference of ±λ/4.

Here, as shown in FIG. 8, when the direction of the left and right temple portions are arranged such that the first retarders 211a and 212a are respectively on the front side of the polarizing plates 211b and 212b and such that the second retarders 211c and 212c are respectively on the back side of the polarizing plates 211b and 212b, the optical characteristic corresponding to the left-handed circularly polarized light is assigned to both the left and right lenses. When the display device 100 alternately displays the different images P1 and P2 for each of the horizontal scanning lines of the display panel 112, one of the images, the image P1, is converted into the left-handed circularly polarized light and the other image P2 is converted into the right-handed circularly polarized light. Therefore, the light of the image P1 that has been converted into the left-handed circularly polarized light is shielded and only the image P2 that has been converted into the right-handed circularly polarized light reaches both the left and right eyes of the viewer who is wearing the passive glasses 200. Thus, the viewer can view the image P2 properly.

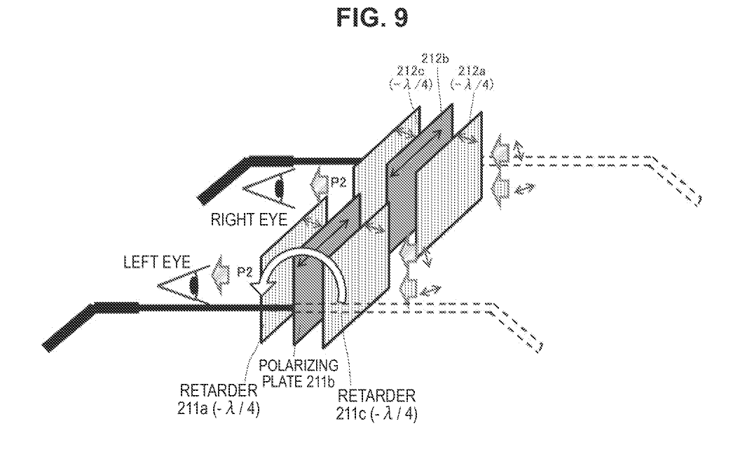

Further, as shown in FIG. 9, when the front-rear direction of the left and right temple portions is switched such that the first retarders 211a and 212a are respectively on the back side of the polarizing plates 211b and 212b and such that the second retarders 211c and 212c are respectively on the front side of the polarizing plates 211b and 212b, the optical characteristic corresponding to the right-handed circularly polarized light is assigned to both the left and right lenses. When the display device 100 alternately displays the different images P1 and P2 for each of the horizontal scanning lines of the display panel 112, one of the images, the image P1, is converted into the left-handed circularly polarized light and the other image P2 is converted into the right-handed circularly polarized light. Therefore, the light of the image P1 that has been converted into the left-handed circularly polarized light is shielded, and only the image P2 that has been converted into the right-handed circularly polarized light reaches both the left and right eyes of the viewer who is wearing the passive glasses 200. Thus, the viewer can view the image P2 properly.

In this manner, with the passive glasses 200 in which the left and right lenses are fixed to the eyeglass frame so that the left and right lenses have the same optical characteristic, it is not possible to observe a three-dimensional image in which a left eye image and a right eye image emit different polarized light. Therefore, although it is necessary to separately have the passive glasses (refer to FIG. 10) for observing three-dimensional images, one type of passive glasses is sufficient to observe the different images P1 and P2. Further, there are advantages in that design constraints of the eyeglass frame are reduced and it is possible to achieve a simple structure and cost reduction.

Additionally, the present technology may also be configured as below:

(1) A video display system including:

a display device which multiplexes and displays a first image and a second image, and which converts light of the first image into first polarized light and converts light of the second image into second polarized light; and

a glasses device which has left and right lenses that are respectively capable of being set to optical characteristics corresponding to the first polarized light and the second polarized light, and which selectively shields one of the light of the first image that has been converted into the first polarized light and the light of the second image that has been converted into the second polarized light.

(2) The video display system according to (1),

wherein the display device includes a three-dimensional image display mode that displays a left eye image and a right eye image as the first image and the second image, and a multiple image display mode that displays images different from each other as the first image and the second image.

(3) The video display system according to (1),

wherein the glasses device sets the optical characteristic corresponding to one of the first polarized light and the second polarized light, in accordance with mounting positions of the left and right lenses.

(4) The video display system according to (1),

wherein the glasses device is capable of setting the optical characteristic corresponding to one of the first polarized light and the second polarized light, separately for the left and right lenses.

(5) The video display system according to (1),

wherein the glasses device is capable of setting the optical characteristic corresponding to one of the first polarized light and the second polarized light, for the left and right lenses as a unit.

(6) The video display system according to (1),

wherein the display device includes a λ/4 phase difference plate that converts each of the first image and the second image to one of left-handed circularly polarized light and right-handed circularly polarized light, and

wherein the left and right lenses of the glasses device are each formed of a polarizing plate that has a first λ/4 phase difference plate on a front side and a second λ/4 phase difference plate on a back side.

(7) The video display system according to (6),

wherein a slow axis of the first λ/4 phase difference plate matches a slow axis of the second λ/4 phase difference plate.

(8) The video display system according to (6),

wherein a slow axis of the first λ/4 phase difference plate and a slow axis of the second λ/4 phase difference plate are displaced from each other by 90 degrees.

(9) The video display system according to (6),

wherein the glasses device includes a reversal mechanism that reverses the front and back of the first λ/4 phase difference plate and the second λ/4 phase difference plate, and

wherein the glasses device sets the optical characteristic to one of an optical characteristic corresponding to the left-handed circularly polarized light and an optical characteristic corresponding to the right-handed circularly polarized light, by reversing the front and back of the first λ/4 phase difference plate and the second λ/4 phase difference plate.

(10) The video display system according to (9),

wherein the reversal mechanism reverses the front and back of the first λ/4 phase difference plate and the second λ/4 phase difference plate, separately for the left and right lenses.

(11) The video display system according to (10),

wherein the reversal mechanism individually and rotatably supports the left and right lenses by a bridge portion between the left and right lenses.

(12) The video display system according to (9),

wherein the reversal mechanism reverses the front and back of the first λ/4 phase difference plate and the second λ/4 phase difference plate, for the left and right lenses as a unit.

(13) The video display system according to (12),

wherein the reversal mechanism switches a front-rear direction of left and right temple portions with respect to an eyeglass frame that holds the left and right lenses.

(14) The video display system according to (1),

wherein the display device includes a λ/2 phase difference plate that converts each of the first image and the second image into one of vertical linearly polarized light and horizontal linearly polarized light, and

wherein the left and right lenses of the glasses device are each formed by a polarizing plate that has a first λ/2 phase difference plate on a front side and a second λ/2 phase difference plate on a back side.

(15) The video display system according to (14),

wherein the glasses device includes a reversal mechanism that reverses the front and back of the first λ/2 phase difference plate and the second λ/2 phase difference plate, and

wherein the glasses device sets the optical characteristic to one of an optical characteristic corresponding to the vertical linearly polarized light and an optical characteristic corresponding to the horizontal linearly polarized light, by reversing the front and back of the first λ/2 phase difference plate and the second λ/2 phase difference plate.

(16) A glasses device including:

left and right lenses that are respectively capable of being set to optical characteristics corresponding to first polarized light and second polarized light,

wherein the glasses device selectively shields one of light of a first image that has been converted into the first polarized light and light of a second image that has been converted into the second polarized light.

(17) The glasses device according to (16),

wherein the left and right lenses are each formed of a polarizing plate that has a first λ/2 phase difference plate on a front side and a second λ/2 phase difference plate on a back side.

(18) The glasses device according to (16), further including:

a reversal mechanism that reverses the front and back of the first λ/2 phase difference plate and the second λ/2 phase difference plate,

wherein the glasses device sets the optical characteristic to one of an optical characteristic corresponding to vertical linearly polarized light and an optical characteristic corresponding to horizontal linearly polarized light, by reversing the front and back of the first λ/2 phase difference plate and the second λ/2 phase difference plate.

(19) The glasses device according to (18),

wherein the reversal mechanism individually and rotatably supports the left and right lenses by a bridge portion between the left and right lenses.

(20) The glasses device according to (18),

wherein the reversal mechanism switches a front-rear direction of left and right temple portions with respect to an eyeglass frame that holds the left and right lenses.

Hereinabove, the technology disclosed in this specification is explained in detail with reference to the specific embodiment. However, it is apparent that a person skilled in the art can perform correction or substitution of the embodiment without departing from the gist of the present technology.

This specification focuses on the embodiment that is applied to the video display system using the pattern retarder method. However, the gist of the technology disclosed in this specification is not limited to this system. The technology disclosed in this specification can also be applied to various types of video display systems using polarized glasses, such as a video display system using an active retarder method.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2012-109151 filed in the Japan Patent Office on May 11, 2012, the entire content of which is hereby incorporated by reference.

What is claimed is:

1. A video display system comprising:
a display device which multiplexes and displays a first image and a second image, and which converts light of the first image into first polarized light and converts light of the second image into second polarized light; and
a glasses device which has left and right lenses that are respectively capable of being set to optical characteristics corresponding to the first polarized light and the second polarized light, and which selectively shields one of the light of the first image that has been converted into the first polarized light and the light of the second image that has been converted into the second polarized light.

2. The video display system according to claim 1,
wherein the display device includes a three-dimensional image display mode that displays a left eye image and a right eye image as the first image and the second image, and a multiple image display mode that displays images different from each other as the first image and the second image.

3. The video display system according to claim 1,
wherein the glasses device sets the optical characteristic corresponding to one of the first polarized light and the second polarized light, in accordance with mounting positions of the left and right lenses.

4. The video display system according to claim 1,
wherein the glasses device is capable of setting the optical characteristic corresponding to one of the first polarized light and the second polarized light, separately for the left and right lenses.

5. The video display system according to claim 1,
wherein the glasses device is capable of setting the optical characteristic corresponding to one of the first polarized light and the second polarized light, for the left and right lenses as a unit.

6. The video display system according to claim 1,
wherein the display device includes a λ/4 phase difference plate that converts each of the first image and the second image to one of left-handed circularly polarized light and right-handed circularly polarized light, and
wherein the left and right lenses of the glasses device are each formed of a polarizing plate that has a first λ/4 phase difference plate on a front side and a second λ/4 phase difference plate on a back side.

7. The video display system according to claim 6,
wherein a slow axis of the first λ/4 phase difference plate matches a slow axis of the second λ/4 phase difference plate.

8. The video display system according to claim 6,
wherein a slow axis of the first λ/4 phase difference plate and a slow axis of the second λ/4 phase difference plate are displaced from each other by 90 degrees.

9. The video display system according to claim 6,
wherein the glasses device includes a reversal mechanism that reverses the front and back of the first λ/4 phase difference plate and the second λ/4 phase difference plate, and
wherein the glasses device sets the optical characteristic to one of an optical characteristic corresponding to the left-handed circularly polarized light and an optical characteristic corresponding to the right-handed circularly polarized light, by reversing the front and back of the first λ/4 phase difference plate and the second λ/4 phase difference plate.

10. The video display system according to claim 9,
wherein the reversal mechanism reverses the front and back of the first λ/4 phase difference plate and the second λ/4 phase difference plate, separately for the left and right lenses.

11. The video display system according to claim 10,
wherein the reversal mechanism individually and rotatably supports the left and right lenses by a bridge portion between the left and right lenses.

12. The video display system according to claim 9,
wherein the reversal mechanism reverses the front and back of the first λ/4 phase difference plate and the second λ/4 phase difference plate, for the left and right lenses as a unit.

13. The video display system according to claim 12,
wherein the reversal mechanism switches a front-rear direction of left and right temple portions with respect to an eyeglass frame that holds the left and right lenses.

14. The video display system according to claim 1,
wherein the display device includes a λ/2 phase difference plate that converts each of the first image and the second image into one of vertical linearly polarized light and horizontal linearly polarized light, and
wherein the left and right lenses of the glasses device are each formed by a polarizing plate that has a first λ/2 phase difference plate on a front side and a second λ/2 phase difference plate on a back side.

15. The video display system according to claim 14,
wherein the glasses device includes a reversal mechanism that reverses the front and back of the first λ/2 phase difference plate and the second λ/2 phase difference plate, and
wherein the glasses device sets the optical characteristic to one of an optical characteristic corresponding to the vertical linearly polarized light and an optical characteristic corresponding to the horizontal linearly polarized light, by reversing the front and back of the first λ/2 phase difference plate and the second λ/2 phase difference plate.

16. A glasses device comprising:
left and right lenses that are respectively capable of being set to optical characteristics corresponding to first polarized light and second polarized light,
wherein the glasses device selectively shields one of light of a first image that has been converted into the first polarized light and light of a second image that has been converted into the second polarized light.

17. The glasses device according to claim 16,
wherein the left and right lenses are each formed of a polarizing plate that has a first λ/2 phase difference plate on a front side and a second λ/2 phase difference plate on a back side.

18. The glasses device according to claim 16, further comprising:
a reversal mechanism that reverses the front and back of the first λ/2 phase difference plate and the second λ/2 phase difference plate,
wherein the glasses device sets the optical characteristic to one of an optical characteristic corresponding to vertical linearly polarized light and an optical characteristic corresponding to horizontal linearly polarized light, by reversing the front and back of the first λ/2 phase difference plate and the second λ/2 phase difference plate.

19. The glasses device according to claim 18,
wherein the reversal mechanism individually and rotatably supports the left and right lenses by a bridge portion between the left and right lenses.

20. The glasses device according to claim 18,
wherein the reversal mechanism switches a front-rear direction of left and right temple portions with respect to an eyeglass frame that holds the left and right lenses.
